(19) United States
(12) Patent Application Publication
(10) Pub. No.: US 2025/0155879 A1
(43) Pub. Date: May 15, 2025

(54) SYSTEM FOR PROCESS DEVELOPMENT ASSISTANCE

(71) Applicant: Tokyo Electron Limited, Tokyo (JP)

(72) Inventors: Sergey AVERKIN, Albany, NY (US); Pingshan LUAN, Albany, NY (US); Toru HISAMATSU, Albany, NY (US)

(21) Appl. No.: 18/389,207

(22) Filed: Nov. 13, 2023

(51) Int. Cl. G05B 19/418; G06F 16/33

(52) U.S. Cl. CPC G05B 19/41865; G06F 16/3344; G05B 2219/45031

(57) ABSTRACT

Systems and methods for process development assistance are disclosed. A system includes one or more processors and memory. The system receives a scorecard including a set of criteria for fabricating a semiconductor device. The system obtains, based on the scorecard, a set of recipes stored in a knowledge base. The system obtains a set of feature dimensions associated with the set of recipes. The system obtains, using an analytic hierarchy process on the set of feature dimensions, the set of criteria, and weights of the set of criteria, an objective function value of each of the set of recipes. The system selects a subset of recipes according to the objective function value of each of the set of recipes. The system generates at least one recipe according to the selected subset of recipes and the objective function value. The system displays, via a display device, the at least one recipe.

### FIELD OF THE DISCLOSURE

This disclosure relates to recipe development including recipes for fabricating semiconductor devices, including systems and methods for process development assistance.

### BACKGROUND

The semiconductor industry has experienced rapid growth due to continuous improvements in the integration density of a variety of electronic components (e.g., transistors, diodes, resistors, capacitors, etc.). For the most part, this improvement in integration density has come from repeated reductions in minimum feature size, which allows more components to be integrated into a given area. As the demand for miniaturization, higher speed, and greater bandwidth, as well as lower power consumption and latency has grown recently, there has grown a need for smaller and more creative packaging techniques of semiconductor dies.

### SUMMARY

Semiconductor devices or wafers can be fabricated by following a process or a recipe. The recipe includes or refers to a set of detailed instructions and parameters used to process semiconductor wafers through various stages of fabrication. The recipe may be an existing recipe or a custom recipe tuned for the specific semiconductor wafer. For example, a set of criteria can be received from a user (e.g., consumer) indicating the various expected features or details of the semiconductor wafer after the fabrication, such as depth of trench, roughness, or other specifications of the semiconductor wafer. In certain systems, a process engineer may search through a database to find an existing recipe satisfying the criteria. In some other cases, the process engineer may perform simulations or experiments on various recipes for fine-tuning and modification of the recipe (e.g., adjusting the detailed instructions or parameters) to satisfy the set of criteria. However, it may be time-consuming and resource-intensive to experimentally fine-tune the recipe, from iteratively running and processing the wafers, e.g., until the criteria are satisfied. Further, simulations may be limited by the training data, complexity of the wafers, variables involved in the fabrication process, constraints of simulation time or simulation sequence, etc. These simulation limitations can introduce discrepancies and prevent accurate predictions of the resulting wafer parameters after the fabrication.

The systems and methods of the technical solution provide various embodiments for process development assistance and optimization tool or system that reduces the time and resources for developing recipes satisfying the criteria from the user (e.g., shorten recipe development cycles). The systems and methods may use experimental results or measurements to develop and optimize the recipe (or best-known method (“BKM”)) for fabricating the semiconductor wafers or devices, for instance, without relying on simulations. The systems and methods can include one or more subsystems to automate the development process and optimization for generating or finding the BKM, which can be provided (or recommended) to the process engineers. The systems and methods may provide information related to the generated BKM satisfying the criteria to the process engineer, for instance, for the process engineer to create a new recipe. The recipe recommendation based on the experimental results can be recorded and stored in a knowledge base for subsequent process development, for example. The knowledge base can be updated with new experimental results and recommendations. Further, the systems and methods of the technical solution can provide a ranking of recommended recipes according to an analytical hierarchy process, which accounts for weights (e.g., importance) of individual criteria. Accordingly, the systems and methods can utilize experimental results and measurements for recommending the optimal recipe(s) satisfying the criteria of the user, thereby reducing the number of experimental steps, minimizing resources for fine-tuning the recipe, avoiding inaccuracies introduced from simulation limitations, and optimizing recipes (or BKM) to reduce the probability of pushback from process engineers.

One embodiment may include a system. The system includes one or more processors and memory. The one or more processors are configured to receive a scorecard including a set of criteria for fabricating a semiconductor device. The one or more processors are configured to obtain, based on the scorecard, a set of recipes stored in a knowledge base. The one or more processors are configured to obtain a set of feature dimensions associated with the set of recipes. The one or more processors are configured to obtain, using an analytic hierarchy process on the set of feature dimensions, the set of criteria, and weights of the set of criteria, an objective function value of each of the set of recipes. The one or more processors are configured to select a subset of recipes according to the objective function value of each of the set of recipes. The one or more processors are configured to generate at least one recipe according to the selected subset of recipes and the objective function value. The one or more processors are configured to display, via a display device, the generated at least one recipe.

In some implementations, to obtain the set of feature dimensions, the one or more processors are configured to: obtain a set of metrology images associated with the respective set of recipes; and convert the set of metrology images to the respective set of feature dimensions. In some implementations, to obtain the set of feature dimensions, the one or more processors are configured to: obtain a plurality of sets of feature dimensions, each set associated with a recipe of the set of recipes. In some implementations, to obtain the set of recipes, the one or more processors are configured to: execute a semantic search in the knowledge base according to the set of criteria; and receive, responsive to the semantic search, the set of recipes comprising one or more recipes having a set of features satisfying at least one criterion of the set of criteria.

In some implementations, the one or more processors are configured to: obtain an identifier associated with the scorecard; store the identifier in the knowledge base; and obtain the set of recipes associated with the identifier. In some implementations, the one or more processors are configured to: store at least one of a set of metrology images, the set of feature dimensions, the subset of recipes, or the at least one recipe in association with the identifier.

In some implementations, a set of metrology images corresponds to scanning electron microscopy (SEM) images. In some implementations, to use the analytic hierarchy process, the one or more processors are configured to: perform a pairwise comparison between a set of features associated with the set of feature dimensions and the set of criteria; obtain a weight of each feature of the set of features according to the pairwise comparison; and obtain the objective function value of each of the set of recipes by using the respective set of feature dimensions, the set of criteria, and the weight as input for an objective function.

In some implementations, each of the set of recipes is ranked according to the respective objective function value, and wherein the subset of recipes is selected according to smallest objective function value. In some implementations, to generate the at least one recipe, the one or more processors are configured to: determine, using at least the objective function value and at least one parameter of the subset of recipes associated with the set of criteria as inputs for an optimization function, an adjustment value for the at least one parameter; and generate the at least one recipe including the adjustment value of the at least one parameter.

In some implementations, the one or more processors are configured to: determine whether the set of feature dimensions of a recipe satisfies the set of criteria of the scorecard; and responsive to the set of feature dimensions satisfying the set of criteria, provide the recipe for display via the display device. In some implementations, the one or more processors obtain the objective function value subsequent to determining that the set of feature dimensions of the recipe does not satisfy the set of criteria of the scorecard.

Another embodiment may include a method. The method includes receiving, by a device comprising one or more processors and memory, a scorecard including a set of criteria for fabricating a semiconductor device. The method includes obtaining, by the device, based on the scorecard, a set of recipes stored in a knowledge base. The method includes obtaining, by the device, a set of feature dimensions associated with the set of recipes. The method includes obtaining, by the device, using an analytic hierarchy process on the set of feature dimensions, the set of criteria, and weights of the set of criteria, an objective function value of each of the set of recipes. The method includes selecting, by the device, a subset of recipes according to the objective function value of each of the set of recipes. The method includes generating, by the device, at least one recipe according to the selected subset of recipes and the objective function value. The method includes displaying, by the device, via a display device, the generated at least one recipe.

In some implementations, obtaining the set of feature dimensions, the method includes obtaining, by the device, a set of metrology images associated with the respective set of recipes. The method includes converting, by the device, the set of metrology images to the respective set of feature dimensions. In some implementations, obtaining the set of feature dimensions, the method includes obtaining, by the device, a plurality of sets of feature dimensions, each set associated with a recipe of the set of recipes.

In some implementations, the method includes obtaining, by the device, an identifier associated with the scorecard. The method includes storing, by the device, the identifier in the knowledge base. The method includes obtaining, by the device, the set of recipes associated with the identifier. In some implementations, the method includes storing, by the device, at least one of a set of metrology images, the set of feature dimensions, the subset of recipes, or the at least one recipe in association with the identifier.

In some implementations, using the analytic hierarchy process, the method includes performing, by the device, a pairwise comparison between a set of features associated with the set of feature dimensions and the set of criteria. The method includes obtaining, by the device, a weight of each feature of the set of features according to the pairwise comparison. The method includes obtaining, by the device, the objective function value of each of the set of recipes by using the respective set of feature dimensions, the set of criteria, and the weight as input for an objective function.

Yet another embodiment may include an apparatus. The apparatus includes a device comprising one or more processors and memory. The device is configured to receive a scorecard including a set of criteria for fabricating a semiconductor device. The device is configured to obtain, based on the scorecard, a set of recipes stored in a knowledge base. The device is configured to obtain a set of feature dimensions associated with the set of recipes. The device is configured to obtain, using an analytic hierarchy process on the set of feature dimensions, the set of criteria, and weights of the set of criteria, an objective function value of each of the set of recipes. The device is configured to select a subset of recipes according to the objective function value of each of the set of recipes. The device is configured to generate at least one recipe according to the selected subset of recipes and the objective function value. The device is configured to display, via a display device, the generated at least one recipe.

In some implementations, the device is configured to: determine whether the set of feature dimensions of a recipe satisfies the set of criteria of the scorecard. Responsive to the set of feature dimensions satisfying the set of criteria, the device is configured to provide the recipe for display via the display device.

These and other aspects and implementations are discussed in detail below. The foregoing information and the following detailed description include illustrative examples of various aspects and implementations and provide an overview or framework for understanding the nature and character of the claimed aspects and implementations. The drawings provide illustrations and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form. As used in the specification and in the claims, the singular form of “a,” “an,” and “the” include plural referents unless the context clearly dictates otherwise.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure. For purposes of clarity, not every component may be labeled in every drawing. In the drawings:

FIG. 1 illustrates a block diagram of a system within a network, in accordance with some embodiments.

FIG. 2 illustrates a flow chart of an example method for process development assistance, in accordance with some embodiments.

FIG. 3 illustrates a flow diagram of another example method for process development assistance, in accordance with some embodiments.

FIG. 4 is a block diagram illustrating an architecture for a computer system that can be employed to implement elements of the systems and methods described and illustrated herein, including, for example, aspects of the overlay measurement system depicted in FIGS. 1-3.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

In certain systems, semiconductor devices or wafers can be fabricated by following a predetermined process, sequence, or recipe. The recipe includes or refers to a set of detailed instructions and parameters used to process semiconductor wafers through various stages of fabrication. The recipe may be an existing recipe or a custom recipe tuned for the specific semiconductor wafer. An objective of using the recipe can include fabricating a semiconductor wafer to have or meet a certain set of criteria.

For example, the set of criteria can be provided by a user indicating the expected features or details of the semiconductor wafer after the fabrication, such as the depth of the trench, roughness, or other specifications of the semiconductor wafer. In certain systems, a process engineer may search through a database to find an existing recipe satisfying the criteria. In some other cases, the process engineer may perform simulations or experiments on various recipes for fine-tuning and modification of the recipe (e.g., adjusting the detailed instructions or parameters) to satisfy the set of criteria. However, it may be time-consuming and resource-intensive to experimentally fine-tune the recipe, from iteratively running and processing the wafers, e.g., until the criteria are satisfied. Further, simulations may be limited by the training data, complexity of the wafers, variables involved in the fabrication process, constraints of simulation time or simulation sequence, etc. These simulation limitations can introduce discrepancies and prevent accurate predictions of the resulting wafer parameters after the fabrication.

The systems and methods of the technical solution provide various embodiments for process development assistance and optimization tool or system that reduces the time and resources for developing recipes satisfying the criteria from the user (e.g., shorten recipe development cycles). The systems and methods may use experimental results or measurements to develop and optimize the recipe (or BKM) for fabricating the semiconductor wafers or devices, for instance, without relying on simulations. The systems and methods can include one or more subsystems to automate the development process and optimization for generating or finding the BKM, which can be provided (or recommended) to the process engineers. The systems and methods may provide information related to the generated BKM satisfying the criteria to the process engineer, for instance, for the process engineer to create a new recipe. The recipe recommendation based on the experimental results can be recorded and stored in a knowledge base for subsequent process development, for example. The knowledge base can be updated with new experimental results and recommendations. Further, the systems and methods of the technical solution can provide a ranking of recommended recipes according to an analytical hierarchy process, which accounts for weights (e.g., importance) of individual criteria. Accordingly, the systems and methods can utilize experimental results and measurements for recommending the optimal recipe(s) satisfying the criteria of the user, thereby reducing the number of experimental steps, minimizing resources for fine-tuning the recipe, avoiding inaccuracies introduced from simulation limitations, and optimizing recipes (or BKM) to reduce the probability of pushback from process engineers.

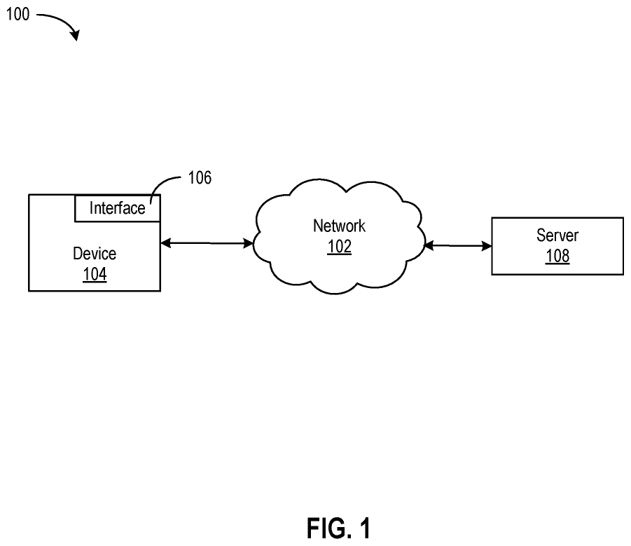

FIG. 1 illustrates a block diagram of a system 100 within a network 102. The system 100 can include, interface with, or utilize one or more networks 102. The system 100 can include, interface with, or communicate with at least one device 104. The system 100 can include, interface with, or utilize one or more servers 108. The one or more components (e.g., device 104 or servers 108) of the system 100 can establish communication channels via the network 102. For example, the device 104 can communicate with the server 108 through the network 102, or vice versa.

The network 102 can include computer networks such as the Internet, local, wide, metro, or other area networks, intranets, satellite networks, other computer networks such as voice or data mobile phone communication networks, and combinations thereof. The network 102 may be any form of computer network that can relay information between the one or more components of the system 100. In some implementations, the network 102 may include the Internet and/or other types of data networks, such as a local area network (LAN), a wide area network (WAN), a cellular network, a satellite network, or other types of data networks. The network 102 may also include any number of computing devices (e.g., computers, servers, routers, network switches, etc.) that are configured to receive and/or transmit data within the network 102. The network 102 may further include any number of hardwired and/or wireless connections. Any or all of the computing devices described herein (e.g., device 104 or servers 108) may communicate wirelessly (e.g., via Wi-Fi, cellular, radio, etc.) with a transceiver that is hardwired (e.g., via a fiber optic cable, a CAT5 cable, etc.) to other computing devices in the network 102. Any or all of the computing devices described herein (e.g., device 104 or servers 108) may also communicate wirelessly with the computing devices of the network 102 via a proxy device (e.g., a router, network switch, or gateway).

The system 100 can include, interface with, or communicate with at least one device 104 (or various devices 104). The device 104 can include at least one processor and a memory, e.g., a processing circuit. The device 104 can include various hardware or software components, or a combination of both hardware and software components. The devices 104 can be constructed with hardware or software components. For example, the device 104 can include, but is not limited to, a mobile device, personal computer, a laptop, or any other type of computing device.

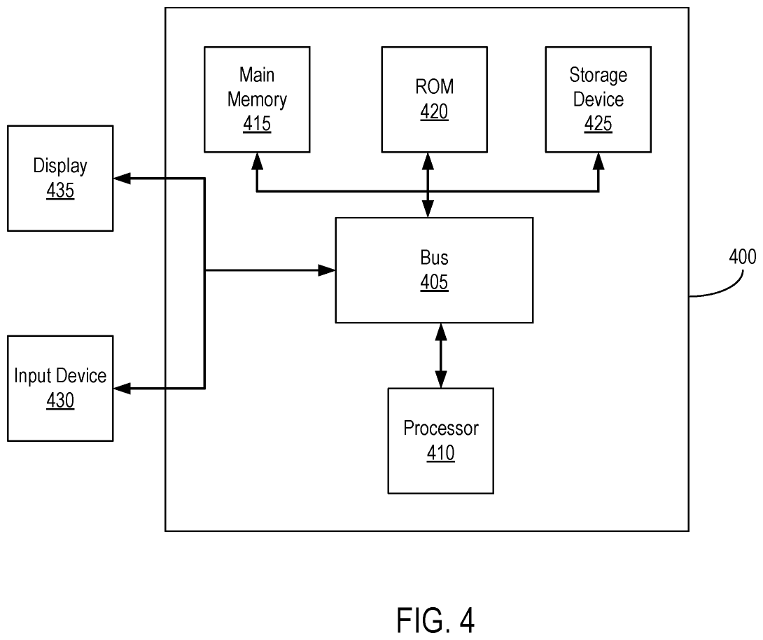

The device 104 can include at least one interface 106 for establishing a connection to the network 102. The device 104 can communicate with other components of the system 100 via the network 102, such as the server 108. The interface 106 can include hardware, software, features, and functionalities of at least a communication interface(s) or user interface. For example, the device 104 can communicate information with one or more servers 108 using the interface 106, including sending or receiving the information. The user interface of the device 104 can include a display device for presenting information to the user of the device 104. The display device can include or correspond to a display 435 described in conjunction with but not limited to FIG. 4.

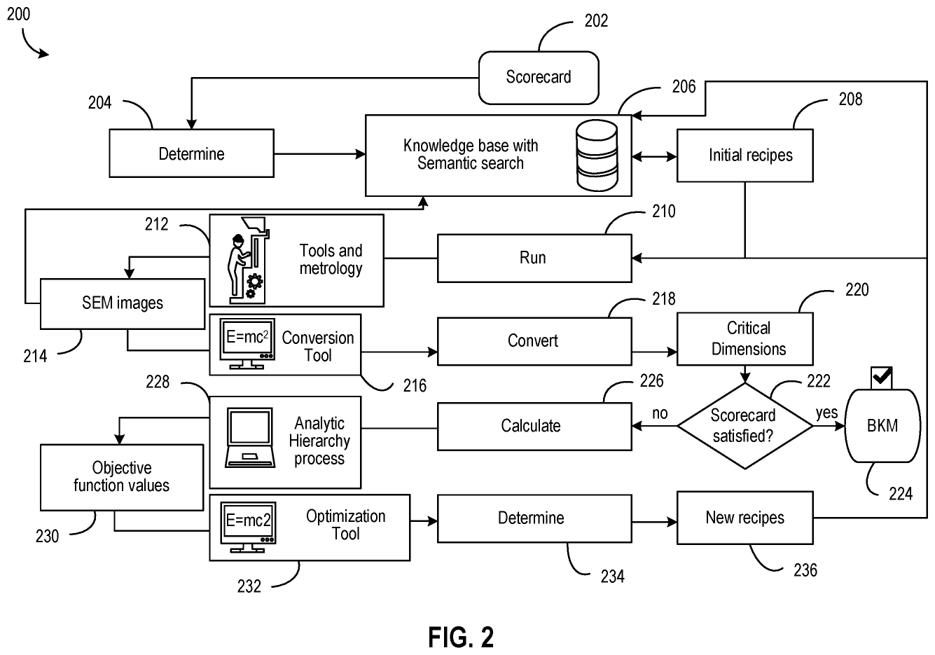

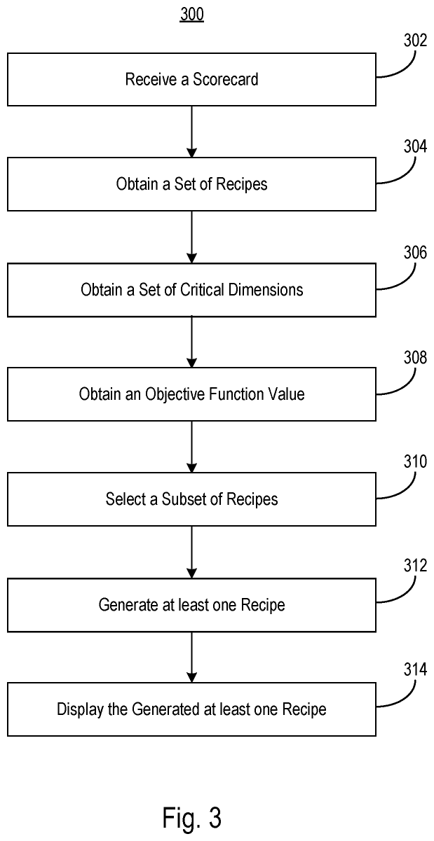

In some cases, the device 104 can include or can be a part of but not limited to the computing device/system 400 of FIG. 4. For example, the device 104 can include one or more components or features of the computing device 400. In some cases, the device 104 can perform features or operations similarly to the computing device 400, or vice versa. The device 104 can include one or more subsystems configured to perform the features or operations of the technical solution discussed herein, such as described in conjunction with at least one of but not limited to FIGS. 2-3.

The system 100 can include, interface with, or communicate with at least one server 108. The server 108 can include at least one processor and a memory. The server 108 can include, be, or be referred to as a remote device, remote entity, or data repository. For example, the server 108 can include or correspond to a knowledge base configured to store information from the device 104, among other devices within the network 102. In this case, the knowledge base can be accessed by the device 104 or other authorized devices. The server 108 can be part of, located in, or form a cloud computing environment. The server 108 can be composed of hardware or software components, or a combination of both hardware or software components. The server 108 can communicate with the device 104 via a communication channel established by the network 102, for example. In some cases, the server 108 can include one or more components similar to the device 104. In this case, the server 108 can be configured to perform features or functionalities similar to the device 104, or vice versa.

| FIG. 2 illustrates a flowchart of an example method 200 for process development assistance. It is noted that the method 200 is merely an example and is not intended to limit the present disclosure. Accordingly, it is understood that additional operations may be provided before, during, and after the method 200 of FIG. 2, and that some other operations may only be briefly described herein. The example method 200 can be executed, performed, or otherwise carried out by one or more components of the system 100 (e.g., network 102, device 104, or server 108), or any other computing devices described herein in conjunction with but not limited to FIG. 1. In some arrangements, the steps of the method 200 can be performed in an order or sequence, not limited to those described in conjunction with FIG. 2.

The process development can refer to the development of a process for fabricating a semiconductor wafer or device, such as developing recipes or fabrication methods. The recipes can include a set of detailed instructions and parameters used to process semiconductor wafers (or other semiconductor structures) through various stages of fabrication, including but not limited to for instance depositing thin films, etching patterns, doping, or other processes involved in creating integrated circuits on the wafers. In various implementations, the recipe can be developed and optimized for various processes, such as including chemical vapor deposition (CVD), physical vapor deposition (PVD), etching, ion implantation, or photolithography, to name a few. Each of these processes can involve specific recipes to achieve the desired layer thickness, pattern, doping profile, etc. The recipe can include one or more parameters, such as time, temperature, gas flow rates, radio frequency (RF) power, substrate bias, pressure, wafer positioning within the equipment/tool, or any other parameters suitable for the operation of the selected or specified tool. As discussed herein, the systems and methods (e.g., the device 104) can include one or more subsystems for determining, generating, or optimizing recipes to satisfy a set of criteria (e.g., trench depth, layer thickness, pattern, doping profile, or roughness).

In various implementations, the device 104 can receive a scorecard 202. The device 104 can receive a scorecard 202 from another device (e.g., client device) within the network 102, such as from a client or user. The scorecard 202 can indicate the desired criteria for the semiconductor wafer or device, such as trench depth, layer thickness, pattern, doping profile, roughness, or any other information identifying the non-limiting characteristics of the device 104. The device 104 can receive the scorecard 202 directly from the client (e.g., client device within the network 102). In some cases, the device 104 can obtain the scorecard 202 from a data repository, such as the knowledge base 206, or other storage devices.

At step 204, the device 104 can perform a (e.g., semantic) search in the knowledge base 206 to determine a set of initial recipes 208. The knowledge base 206 can be local to the device 104 (e.g., a data storage of the device 104). The knowledge base 206 can be remote from the device 104 (e.g., a data storage of the server 108). The knowledge base 206 can include historical recipes, BKMs, or other public or private information (e.g., published papers, public methods, or internal projects). The recipes can include or correspond to BKMs, which refer to procedures, processes, or techniques that are recognized (e.g., utilized) as effective for achieving a specific result (e.g., the resulting features of a wafer). The BKMs can be stored in the knowledge base 206 as the techniques or at least one recipe that is selected or used by the process engineer, which may be at least one of the recipes provided in a past recommendation. Herein, a BKM may correspond to or be used interchangeably as a recipe to be recommended to the user. The device 104 can determine the set of initial recipes 208 according to the scorecard 202. The initial recipes 208 can include the historical recipes with known wafer features resulting from processing the semiconductor wafer with predetermined parameters.

For example, the device 104 can identify the set of criteria indicated by the scorecard 202. In some configurations, for a certain scorecard, the characteristic(s) of the substrate material may be predetermined, e.g., ACL or SiO2, as well as the purpose of the process. With the CDs of the scorecard 202, any recipes satisfying the set of criteria can be identified accordingly. For example, with the CDs identifying the high aspect ratio etching and etch material, the corresponding processing gases can be obtained. With the gas information and substrate information, the device 104 can subsequently find the flow rates and powers, such as utilizing the knowledge base 206 discussed herein, for example.

| According to the set of criteria, the device 104 can search through the (e.g., historical) recipes in the knowledge base 206. Each historical recipe can include known resulting features from fabricating the wafer using respective parameters. The device 104 can determine whether one or more historical recipes include or result in features that satisfy one or more criteria from the scorecard 202. A feature (or a type of feature) associated with a historical recipe can satisfy a respective criterion when the feature is within a predetermined range (e.g., percentage, millimeters (mm), nanometers (nm), or other values) from the criterion. For instance, if the criterion indicates a trench depth or width, the device 104 may determine that the feature (e.g., feature metric or value) satisfies the criterion if the depth or width of the historical trench is within a predetermined range (e.g., within 10 or 50 nm of deviation) from the indicated trench depth or width. In another example, if the criterion indicates the creation of certain structures, such as well structures, via structures, etc., the device 104 can determine that the feature associated with the historical recipe satisfies the criterion if the resulting wafer from using the historical recipe includes the indicated structures.

In some cases, the device 104 can search for initial recipes 208 from the knowledge base 206. In some implementations, the device 104 can determine the initial recipes 208 according to an identification of the scorecard 202. For example, in response to receiving the scorecard 202, the device 104 can determine or generate an identifier for the scorecard 202. The generated identifier for the scorecard 202 can be based on information indicated in the scorecard 202, such as a client number (e.g., customer number) representing the entity requesting the fabrication, a project number for fabricating the specific wafer, or other information for conversion to an identifier. The device 104 can store the determined identifier of the scorecard 202 in the knowledge base 206. Subsequently, information related to the scorecard 202, such as information received, generated, or determined in accordance with but not limited to the operations of at least FIG. 2, can be stored in the knowledge base 206 and associated with the corresponding identifier. Similar operations for determining the identifier of a scorecard 202 and storing related information in the knowledge base 206 can be performed for other scorecards. In this case, if the device 104 determines that the identifier of the received scorecard 202 matches an existing identifier stored in the knowledge base 206, the device 104 can retrieve at least one recipe or BKM (e.g., historically) stored in association with the identifier, e.g., BKM 224 or recipe 236.

In some implementations, the device 104 can receive pre-selected initial recipes 208 from the user (e.g., of the client device) or the process engineer (e.g., administrator) administering the device 104. For example, the device 104 can receive the scorecard 202 along with the pre-selected initial recipes 208 from the client device. The device 104 can store the initial recipes 208 from the client device in the knowledge base 206 in association with the scorecard identifier. In another example, the scorecard 202 may be reviewed by the administrator. The administrator, using the device 104, may select at least one recipe from the knowledge base 206 as the initial recipe 208. For purposes of providing examples herein, the device 104 can determine a set of initial recipes 208 including multiple candidate recipes as at least one potential BKM.

At step 210, a process engineer or, in some implementations, the device 104 (or in some implementations, an administrator or operator) can run or execute at least one suitable tool for generating samples followed by the metrology (e.g., tool 212), using the initial recipes 208 as input, to generate one or more images 214. The image 214 can include at least one of scanning electron microscope (SEM) image, transmission electron microscope (TEM) image, atomic force microscope (AFM) image, optical microscopy image, or other types of images or process characteristics that are used to quantify the quality of the process. The images 214 can include high-resolution images of the surface of materials. The images 214 can provide detailed information about the surface structure, composition, and microstructure of materials, for example. The tool 212 for obtaining the images 214 can correspond to the type of images, for instance, a scanning electron microscope for SEM image, a transmission electron microscope for TEM image, etc.

| In some configurations, the tools 212 can include various devices or systems for fabricating a (e.g., sample) semiconductor device or wafer, and capture the images 214. For example, responsive to or after determining the initial recipes 208, the device 104 can send the initial recipes 208 to the tool 212 for execution. For each initial recipe 208, the tool 212 can fabricate a semiconductor device or wafer according to the recipe, e.g., generate experimental results using the recipe. Subsequently, the tool 212 can capture the images 214 of the semiconductor device or wafer fabricated using the respective recipe. The images 214 can be used to determine the measurements (e.g., metrology) associated with the semiconductor device or wafer. These images 214 and their metrology can be stored in the knowledge base 206 in association with the scorecard identifier and the respective initial recipe 208. In some cases, if the initial recipes 208 existed in and are obtained from the knowledge base 206, corresponding images 214 may be provided along with the initial recipes 208. In this case, the tool 212 may skip the capturing image operation. In some other cases, the tool 212 can capture the images 214 of the semiconductor device or wafer fabricated using existing recipes (e.g., initial recipes 208) obtained from the knowledge base 206, e.g., the initial recipes 208 may be used on a new version of tools or different tools.

In another example, the device 104 may present or provide the initial recipes 208 to the administrator. The administrator can operate or execute the tools 212 using each initial recipe 208, such as to fabricate the semiconductor device or wafer. The tools 212 can capture the images 214 and measurements of the fabricated semiconductor device or wafer. The tools 212 can send a signal including the captured images 214 can measurements to the device 104 or the knowledge base 206 for storage. By storing the images 214 and the measurements in the knowledge base 206, the information can be accessed when similar initial recipes 208 are reused.

In some implementations, the images 214 may be included in the knowledge base 206 in association with respective recipes. For example, responsive to determining the initial recipes 208, the device 104 can obtain associated images 214 and measurements of the semiconductor device or wafer that resulted from executing the respective initial recipes 208. After obtaining the images 214, the device 104 can input the images 214 to a conversion tool 216. The conversion tool 216 may be a part of the device 104. In some cases, the conversion tool 216 can be a separate device or system from the device 104.

At step 218, responsive to inputting the images 214 to the conversion tool 216, the conversion tool 216 can convert each image 214 to the corresponding critical dimensions (CDs) 220. The CDs 220 can refer to dimensions, measurements, or specifications of features of the semiconductor wafer or device associated with the images 214. The CDs 220 can sometime be referred to as feature dimensions, device dimensions, or other interchangeable terms. In some cases, converting the images 214 to CDs 220 can include or correspond to extracting the CDs 220 from the images 214. The CDs 220 can include or represent the measurements of features of the semiconductor device or wafer, such as trench depth and width, roughness, metal line width, wafer thickness, etc. For example, for SEM images, the conversion tool 216 can include SEM manipulation tools for automatic or semi-automatic CD extraction or analyze etch rate measurements, such as based on coupon experiments (or coupon tests). In some cases, the CDs 220 can represent the features of the semiconductor device or wafer, for comparison with the set of criteria from the scorecard 202. The device 104 may store the CDs 220 in the knowledge base 206 in association with the scorecard identifier and the corresponding recipes.

At step 222, the device 104 can determine whether the scorecard 202 (e.g., the set of criteria) is satisfied according to the CDs 220 of each initial recipe 208. This determination can be a part of a metrology analysis. The CDs 220 can be within a predetermined range or value to satisfy at least a portion of the scorecard 202, and outside the predetermined range to not satisfy the scorecard 202. The predetermined range or value, such as a target value and its tolerance or a minimum value, among other values, can be configured by the administrator of the device 104 or the user of the client device. The predetermined range can be in accordance with a process used to produce a certain selectivity. For example, if the target selectivity is 5, then any process with a selectivity greater than 5 can be accepted. In essence, from mathematical point of view we have a range [5, infinity). In some cases, the criteria of the scorecard 202 can include a value range, such as a range of thickness, width, or depth that can satisfy the scorecard 202. In some aspects, the set of criteria can include a specific value for at least one feature (or measurement) of the semiconductor device or wafer. For example, the value can indicate a type of material used during the fabrication of at least one structure of the semiconductor wafer. In another example, the value can indicate the number of components of the semiconductor wafer, such as a specific number of transistors, structures, or layers. In some configurations, the CDs 220 are within the one or more of the criteria to satisfy the scorecard 202. In some other configurations, the CDs 220 are within all the criteria to satisfy the scorecard 202.

Subsequent to or responsive to the determination, if the CDs 220 satisfy the scorecard 202, the device 104 can deposit or store the respective initial recipe 208 that is associated with the CDs 220 (along with other related information, including CDs 220 and images 214) to the knowledge base 206, and label this initial recipe 208 as a (e.g., potential) BKM 224 for the scorecard 202. The device 104 can determine whether there are other CDs 220 that satisfy the scorecard 202. The device 104 can label other initial recipes 208 associated with CDs 220 satisfying the scorecard 202 as potential BKMs 224. The device 104 can present the one or more BKMs 224 to the administrator as recommendations.

For example, responsive to determining the BKMs 224, the device 104 can present a graphical user interface of the BKMs 224 (or their associated recipes) to the administrator via a display device. In some cases, the BKMs 224 can be presented via any type of visual, auditory, tactile, or other sensory feedback to the administrator. The device 104 can receive an indication of a selection (e.g., click, touch, or voice command) from the administrator selecting at least one of the BKMs 224 to be used for fabricating the semiconductor wafer. In some cases, the device 104 can receive an indication from the administrator to edit or modify at least one BKM 224. In some aspects, responsive to a selection of at least one BKM 224, the device 104 can send the BKM 224 (e.g., the selected recipe) to one or more fabrication tools (e.g., design of experiment (DoE) tools or other automatic recipe creators) for fabricating a semiconductor wafer according to at least one of the scorecard 202 (e.g., number of wafers to fabricate), the selected recipe or BKM 224, among other variables.

In some implementations, if the CDs 220 do not satisfy the scorecard 202, the device 104 can store the associated recipe (along with other related information including the CDs 220 and the images 214) to the knowledge base 206 and proceed to step 226. In this case, the device 104 can proceed to find a new recipe or optimize the existing recipe (e.g., the initial recipe 208) to satisfy the scorecard 202.

At step 226, the device 104 can calculate one or more objective function values 230 using an analytic hierarchy process (AHP) 228 (e.g., sometimes referred to as process 228). The AHP 228 can be a subsystem of the device 104. In some cases, the AHP 228 may be executed on a separate device from the device 104, in which case, the device 104 can communicate with the separate device for interchanging data. By using the AHP 228, the objective function values 230 are calculated for optimizing the recipe (e.g., the initial recipe 208 that did not satisfy the scorecard 202). For example, using the AHP 228, the device 104 can translate or convert a multi-objective optimization to a single-objective optimization represented by the objective function value. The multi-objective optimization can refer to a computational approach for optimizing multiple objectives, for instance, optimizing multiple features (or CDs 220) to satisfy the criteria of the scorecard 202. However, certain features may be relatively more desirable (or suitable) than others, and excessive resources may be consumed from attempting to optimize all the features simultaneously or from focusing primarily on the most desired features. For example, addressing the multi-objective optimization challenges can include reducing the multi-objective optimization to a single objective via a linear scalarization procedure, e.g., by introducing the weights to each individual objective and forming a sum of weighted objectives. However, finding the weights to perform the reduction to the single objective can be challenging. As discussed herein, by using the AHP 228, the device 104 can obtain the weights, such as from the knowledge base 206, according to the knowledge or experience of the process engineer for example. In this case, the process engineers are not required to manually provide values for the weight to optimize the system (e.g., relying on the knowledge base 206). By converting the multi-objective optimization to a single-objective optimization, the device 104 can utilize a computational approach to determine a subset of or a ranking of recipes (e.g., from the initial recipes 208) to optimize (e.g., by an optimization tool 232, optimization subsystem, or optimizer).

For example, the device 104 can calculate or determine an objective function value 230 for each recipe using the AHP 228 according to the respective CDs 220 and the scorecard 202, as discussed herein. Accordingly, the device 104 can select one or more recipes according to the objective function values 230. The AHP 228 can represent a deterministic approach to finding an objective function value 230 representing each respective recipe (e.g., the initial recipe 208 that did not satisfy the scorecard 202). The objective function values 230 can represent whether the resulting features of the semiconductor wafer from using the recipe are relatively close or distal from the set of criteria.

In various implementations, the AHP 228 can be a methodology for determining the weight of the multi-objective optimization from a set of pairwise comparisons. The AHP 228 can be used for ranking alternative recipes and generating the weights for individual features to formulate a single objective function optimization because not all features are equally important (e.g., some features are more important than others). As part of the AHP 228, the device 104 can pair each of the features with each other, e.g., for three features, a first feature paired with a second feature, the first feature paired with a third feature, the second feature paired with the third feature, etc., to form a plurality of feature pairs. With input from an administrator or using existing (or prior rankings from the knowledge base 206, the device 104 can perform a pairwise comparison to rank the feature pairs according to the importance (or essentiality) of each CD 220 with respective to other CDs 220 in fabricating the semiconductor wafer. The pairwise comparison can be performed using a pairwise comparison matrix (PCM). The device 104 can rank the CDs 220 inside a respective pair of CDs 220. For example, for a first pair of features including a first feature and a second feature, if the first feature is equally important to the second feature, a value of 1 (e.g., 1:1, 3:3, or 5:5) can be assigned or determined for the first pair. For a second pair including the first feature and a third feature, if the first feature is relatively more desired (or important) than the third feature, a value greater than 1, such as 3, 5, or 7 (e.g., 3:1, 5:1, or 7:1, respectively) can be assigned, where the relatively higher value represents the first feature and the relatively lower value represents the third feature, or vice versa depending on the configuration. The corresponding pair of the third and the first feature can get the reciprocal value, such as 1/3, 1/5, or 1/7 (e.g., 1:3, 1:5, or 1:5, respectively).

The greater the importance of a feature relative to another feature can be represented by a relatively greater value or ratio. Further, the lower importance of a feature relative to another feature can be represented by a relatively lower value or ratio. For instance, for a third pair including the second feature and the third feature, if the second feature is relatively less desired than the third feature, a value of 0.5 (e.g., 1:2, 2:4, or 5:10, respectively) may be assigned. In some implementations, the importance of individual features can be configured by the administrator or the user. An example scale for the assigned values (e.g., representing the feature's importance) can be shown in, but not limited to, an example Table 1.

EXAMPLE TABLE 1
Scale

| | |
|---|---|
| 1 | Equal importance |
| 3 | Moderate importance of one over another |
| 5 | Strong or essential importance |
| 7 | Very strong or demonstrated importance |
| 9 | Extreme importance |
| 2, 4, 6, 8 | Intermediate values |

Use reciprocals for inverse comparisons

Based on the AHP 228, the target metrics weights (e.g., weights of the features) can be constructed from the PCM. The device 104 can obtain the weights or contributions of each CD 220 after ranking the CDs 220 inside each pair. The device 104 can input the weights into the resulting objective function. The weights can be represented as the eigenvalues of the PCM, used in an objective function to determine the objective function values 230.

The device 104 may compute the objective function for each CD 220 to compare each CD 220 with its scorecard value (e.g., scorecard ranges). For example, the criteria for the selectivity production can be greater than 5.0. The device 104 can utilize a maximum between zero (e.g., indicating that the criteria are satisfied) and the relative error for non-zero CDs 220 for the objective function of the CD 220 (e.g., denoted as f_CD) calculation: f_CD=max (0, (CD−CD_target)/CD_target). If the target CD is relatively close to (or is around) zero, the device 104 can use the difference: f_CD=max (0, CD−CD_target)). If a CD 220 is provided that should be less than a certain value, the device 104 can use f_CD=max (0, (CD_target−CD)/CD_target). If we are given a particular value of CD 220, the objective function of the CD 220 can be f_CD=abs ((CD−CD_target)/CD_target)) or f_CD=abs (CD−CD_target). Because the absolute function may not be differentiable at zero, the device 104 can use a square function. As described herein, for simplicity and for purposes of providing examples, the device 104 can use the square function.

In some configurations, the device 104 can filter at least one criterion from the scorecard 202 according to its weight. An example of the objective function can be shown in the example formula (1).

$$f ( {r}_{1} , {r}_{2} , … , {r}_{N} ) = {\sum }_{i = 1}^{N} {w}_{i} max {\{ 0 ; ( 1 - \frac{{v}_{i}}{{v}_{i 0}} ) \}}^{2} \qquad ( 1 )$$

The denoted r₁, r₂, . . . , r_{N} can represent recipe parameters, e.g., the N₂ flow rate. The denoted vᵢ can represent the measured metric value (e.g., CD 220 of a feature or the measured feature value). The denoted vᵢ₀ can represent the target metric value (e.g., the targeted criterion indicated in the scorecard 202). The result of 0 from

$$max {\{ 0 ; ( 1 - \frac{{v}_{i}}{{v}_{i 0}} ) \}}^{2}$$

can indicate that the measured metric value corresponds to the BKM (e.g., satisfy the criteria or the target metric value that in this case takes the form vᵢ≥ vᵢ₀). The value

$$max {\{ 0 ; ( \frac{{v}_{i}}{{v}_{i 0}} - 1 ) \}}^{2}$$

can be used for the CDs 220 with vᵢ≤vᵢ₀. If the CDs 220 are around zero, the following relations can be utilized: max{0; (vᵢ₀−vᵢ)}² for vᵢ>vᵢ₀ and max{0; (vᵢ−vᵢ₀)}² for vᵢ≤Vᵢ₀. If an exact matching of the CDs 220 is desired for the scorecard 202, the device 104 can use

$${( 1 - \frac{{v}_{i}}{{v}_{i 0}} )}^{2}$$

for non-zero vᵢ₀ and (vᵢ−vᵢ₀)² when the vᵢ₀ is around zero. The objective functions provided are non-limiting examples, and other expressions can be used to represent the objective functions based on the actual CDs 220. The denoted wᵢ can represent the metric weight of the feature associated with the measured or targeted metric value. The device 104 can perform the ranking of the different features once or repeated in other iterations when determining a new recipe 236, depending on the configuration (or preferences of the administrator). In some arrangements, the device 104 may create multiple rankings (e.g., different importance configured by the administrator) to increase the diversity of the recipes.

An example usage of the AHP 228 can be provided herein for two parameters, for simplicity, although other number of parameters can be configured. It should be noted that the examples provided herein are not intended to be limiting and can include, for example, other types of parameters or an additional number of parameters. For example, the scorecard 202 can indicate an oxide (OX)/amorphous carbon layer (ACL) selectivity and an OX distortion as parameters to be satisfied. The scorecard 202 can indicate the OX/ACL selectivity of 5:1 (or more) and OX distortion of 0.900 (or more). The measured OX/ACL selectivity may be 4.5:1 and the measured OX distortion may be 0.846, for example. The example parameters can be shown in the example Table 2.

EXAMPLE TABLE 2

| PARAMETER | TARGET | MEASURED |
|---|---|---|
| OX/ACL Selectivity | 5:1 | 4.5:1 |
| OX Distortion | 0.900 | 0.846 |

Further from the example, the OX distortion parameter may be relatively more desired (or important) compared to the OX/ACL selectivity parameter. Between these two parameters, the scale of importance can be 3:2, associated with the OX distortion parameter and the OX/ACL selectivity parameter, respectively. A PCM between these parameters can be shown in the example Table 3.

EXAMPLE TABLE 3

| PARAMETER | OX Distortion | OX/ACL Selectivity |
|---|---|---|
| OX Distortion | 1 | 3/2 |
| OX/ACL Selectivity | 2/3 | 1 |

The ratio or value in the example Table 3 can be represented as X/Y, where X represents the scale value of the parameter of each row, and Y represents the scale value of the parameter of each column. With the PCM, corresponding weights of the OX distortion and the OX/ACL selectivity can be determined. For example, the device 104 can normalize eigenvectors of the PCM with an eigenvalue of 2 in this case (e.g., the eigenvalue representing the number of dimensions of the PCM). The resulting weight from the AHP 228 can be shown in the example Table 4.

EXAMPLE TABLE 4

| PARAMETER | WEIGHTS |
|---|---|
| OX Distortion | 0.6 |
| OX/ACL Selectivity | 0.4 |

As shown in the example Table 4, a relatively higher weight represents a relatively more desired or important parameter (e.g., feature in this case) for the fabrication of the semiconductor wafer. The weights, targeted metric values, and the measured metric values can be inputted to the objective function (e.g., the example function (1)), resulting in the example function (2). Accordingly, the device 104 can determine the objective function value 230 of the recipe associated with the OX/ACL selectivity of 4.5:1 and the OX distortion of 0.846. The device 104 can perform the AHP 228 for other recipes to determine their objective function values 230.

$$f ( {r}_{1} , {r}_{2} , … , {r}_{N} ) = 0.4 max {\{ 0 ; ( 1 - \frac{{v}_{O X / A CL sel}}{5.0} ) \}}^{2} + 0.6 max {\{ 0 ; ( 1 - \frac{{v}_{OX dist}}{0.9} ) \}}^{2} \qquad ( 2 )$$

The AHP 228 can be utilized for other recipes. Referring to the above examples, other recipes may include different OX distortion or OX/ACL selectivity values as a result of different nitrogen (N₂) flow rate parameter, such as presented in an example Table 5. Subsequent to performing the PCM and using the example formula (1), the device 104 can determine the objective function value 230 of each recipe from the example Table 5. The resulting objective function values 230 of the recipes can be shown in an example Table 6. As shown in this case, the most optimal recipe (e.g., with the lowest objective function value 230) to the least optimal recipe (e.g., with the highest objective function value 230) can include recipe #3, recipe #2, recipe #4, recipe #1, and recipe #5.

| | N₂ Flow | OX | OX/ACL |
|---|---|---|---|
| Recipe # | Parameter | Distortion | Selectivity |
| 1 | 0 sccm | 0.700 | 4.46 |
| 2 | 30 sccm | 0.856 | 4.48 |
| 3 | 60 sccm | 0.859 | 4.14 |
| 4 | 90 sccm | 0.784 | 3.97 |
| 5 | 120 sccm | 0.600 | 3.90 |

According to the example formula (1), the device 104 can determine an objective function value 230 for each recipe, representing the single-objective function. The device 104 can select one or more of the recipes having the smallest objective function value 230 relative to other recipes. These selected recipes can be provided to the optimization tool 232 for determining or calculating the next candidate recipe (e.g., new recipe 236).

At 234, the device 104 can use the optimization tool 232 to determine the next candidate recipe. The optimization tool 232 can be a part or a subsystem of the device 104. In some cases, the optimization tool 232 can be a part of a separate system in communication with the device 104. For example, the device 104 (e.g., the optimization tool 232) can use the objective function values 230 and the recipe parameters (or features) to compute the gradient of the objective function values 230. Referring to the above example, the device 104 can compute the gradient of the N₂ flow rate to determine an approximate N₂ flow rate that can allow the features of the semiconductor device to potentially satisfy the criteria, for example. The computation can be performed using an example formula (3) representing a central-difference approximation to the gradient. Other approximations may be used by the device 104, not limited to the central-difference approximation, such as forward-difference approximation, among others. The central-difference approximation can utilize two functional values, where one can be larger and the other can be smaller than the value computed for the gradient.

$$∇ {f ( {r}_{1} , {r}_{2} , … , {r}_{N} )}_{i} = \frac{\begin{matrix}f ( {r}_{1} , {r}_{2} , … , {r}_{i} + Δ {r}_{i} , … , {r}_{N} ) - \\ f ( {r}_{1} , {r}_{2} , … , {r}_{i} - Δ {r}_{i} , … , {r}_{N} )\end{matrix}}{2 Δ {r}_{i}} \qquad ( 3 )$$

The denoted i can represent the i^{th} gradient component. A number of recipes can be selected from step 226 as inputs to the example formula (3) for calculating the parameter value to be used for the new recipe 236. In case of an excessive number of recipes (e.g., the number of selected recipes greater than or equal to a predetermined threshold), the device 104 can use a least-square method, or other computational techniques not limited to those discussed herein, to compute the gradients.

For example, a gradient descent or conjugate gradient method, among other optimization techniques, can be combined or used to form an example formula (4) representing the vector of recipe conditions r with elements (r₁, r₂, . . . , r_{N}) denoting the recipe conditions and rₖ representing the k^{th} step of the optimization process, although other suitable computation techniques can be used to achieve certain results, not limited to those discussed herein. Further, by using different weights generated via the AHP 228, the device 104 can provide a diversified set of candidate recipes.

$${r}_{k + 1} = {r}_{k} + {α}_{k} {d}_{k} , {d}_{k} = - ∇ {f}_{k} + {α}_{k} {d}_{k - 1} , {d}_{0} = - ∇ {f}_{0} \qquad ( 4 )$$

The optimization tool 232 can account for tool guidelines via barrier functions for constraints associated with tool guidelines as additional terms that can be added to the function ƒ(r₁, r₂, . . . , r_{N}). For example, the optimization tool 232 can operate in the range of pressures or, for instance, the nitrogen flow rate can be within a predetermined upper limit. Then, the objective function can be modified, given that the flow rate does not exceed 150 sccm (or other flow rate values), as follows:

$$f ( {r}_{1} , {r}_{2} , … , {r}_{N} ) = 0.4 max {\{ 0 ; ( 1 - \frac{{v}_{O X / ACL sel}}{5.0} ) \}}^{2} + 0.6 max {\{ 0 ; ( 1 - \frac{{v}_{OX dist}}{0.9} ) \}}^{2} - ϵln ( 150 - {r}_{{N}_{2}} ) .$$

The ∈ can denote a relatively small number (e.g., 1e-8). In this case, for instance, if the tentative flow rate exceeds 150 sccm, the objective function may output infinity. The gradient of the function can point away from 150 to ensure that the objective function stays within bounds. For purposes of providing examples, a bounds check may be used, although for other complex computations, at least one suitable barrier function may be utilized.

In further examples, if one of the recipe parameters, rᵢ, is less than rᵢ₀ due to tool or process limitations, a term −∈ ln(rᵢ₀−rᵢ) can be added to the objective function, where ∈ can denote a relatively small number, for instance, 10⁻⁸, that can be adjusted during the optimization step. Other tools and techniques can be utilized by the device 104, not limited to those described herein.

For purposes of demonstrating the optimization tool 232, the above non-limiting example can be referred to herein for finding an optimum N₂ flow rate value for tuning or modifying the recipe. For example, using the example formula (3), the device 104 can determine a gradient component (e.g., central-difference scheme) at the minimum of objective function corresponding to the N₂ flow rate of 60 sccm as follows:

$$∇ {f}_{0} ( {r}_{{N}_{2}} = 60 s s c m ) = \frac{f ( {r}_{{N}_{2}} = 90 s s c m ) - f ( {r}_{{N}_{2}} = 30 s s c m )}{2 ( 90 - 30 )} \approx 0.000120384$$

Further, the device 104 can use at least one step of an optimization technique or algorithm and fractional steps to construct a new set of recipes. For example, the device 104 can use the gradient descent technique with the Barzilai-Borwein step (e.g., the example formula (4)) to determine an N₂ flow rate denoted by r₁ for testing, as follows:

$${d}_{0} = - ∇ {f}_{0} = - 0.0001203 \; 84 ,$$

$${α}_{1} = \frac{\vert ( {\tilde{r}}_{0} - {r}_{0} ) ( ∇ {\tilde{f}}_{1} - ∇ {f}_{0} ) \vert}{{‖ ∇ {\tilde{f}}_{1} - ∇ {f}_{0} ‖}^{2}} = 575 \; 48 ,$$

$${r}_{1} = 60 - {α}_{1} ∇ {f}_{0} = 53.072 ,$$

In this case, responsive to utilizing the optimization tool 232, the device 104 can determine that the N₂ flow rate to be tested is 53.072 standard cubic centimeters per minute (sccm). This N₂ flow rate (or other parameters) of the recipe to be tested can represent a potentially optimal parameter that may result in the targeted metric value, such as around 5:1 OX ACL selectivity and 0.9 OX distortion, referring to the above example. The device 104 can provide the determined parameter from the optimization tool 232 as part of at least one new recipe 236. The device 104 can generate additional or alternative new recipes 236 according to different weights of the parameters, features, or criteria, for example. In some cases, the device 104 can present the new recipes 236 or the one or more optimum parameters to the administrator. The device 104 may receive a new or adjusted value of the parameter from the administrator. The device 104 can generate a new recipe 236 according to the adjusted parameter value. In some cases, the device 104 may receive one or more new recipes 236 created by the administrator or from other devices.

The device 104 can store the new recipes 236 in the knowledge base 206 in association with the scorecard identifier. The new recipes 236 can be used as part of the initial recipes 208 in a subsequent iteration of the processes (e.g., steps 210, 218, 226, or 234) for determining the BKM 224. In some implementations, the device 104 may label the one or more new recipes 236 as BKMs 224 for recommendation and selection by the administrator.

FIG. 3 illustrates a flow diagram of an example method 300 for process development assistance, in accordance with an embodiment. The example method 300 can be executed, performed, or otherwise carried out by one or more components of the system 100 (e.g., device 104 or server 108), or any other computing devices described herein in conjunction with FIG. 1. The method 300 can include a device (e.g., the device 104 including one or more processors, coupled with memory) receiving a scorecard, at step 302. At step 304, the device can obtain a set of recipes. At step 306, the device can obtain a set of critical dimensions. At step 308, the device can obtain an objective function value. At step 310, the device can select a subset of recipes. At step 312, the device can generate at least one recipe. At step 314, the device can display the generated at least one recipe.

In further detail, at step 302, the device can receive a scorecard including a set of criteria for fabricating a semiconductor device. The device can receive the scorecard from a client device, where the set of criteria is configured by the client or the user. The set of criteria can include one or more targeted metric values (e.g., target feature metrics) to be met, such as a range of depth, width, uniformity, or other dimensions of the structures of the semiconductor device or wafer.

At step 304, the device can obtain a set of recipes stored in a knowledge base (e.g., 206) on the scorecard. The set of recipes can include initial recipes for analysis. For example, to obtain the set of recipes, the device may perform or execute a semantic search in the knowledge base according to the set of criteria. By executing the semantic search, the device can identify the set of recipes that can be used to form the semiconductor wafer including at least one of but not limited to the structures, types of materials, etc., specified in the scorecard (e.g., as part of the set of criteria). Responsive to executing the semantic search, the device can receive the set of recipes including one or more recipes having (e.g., or that when executed, result in) a set of features of the semiconductor wafer satisfying at least one criterion of the set of criteria.

In some implementations, the device can obtain or generate an identifier associated with the scorecard. The identifier can include a value, character, or any form of indication representing, for instance, the client that provided the scorecard, the type of project, or other information related to the scorecard. The device can store the identifier in the knowledge base in association with the scorecard. In some cases, the identifier may be previously stored in the knowledge base, associated with an existing set of recipes. In this case, the device can use the identifier of the scorecard to retrieve the set of recipes for identifying at least one BKM. In some other cases, if new set of recipes are obtained, the device can store the new set of recipes in association with the identifier for subsequent retrieval.

At step 306, the device can obtain a set of critical dimensions associated with the set of recipes. The set of critical dimensions can include, correspond to, or represent the measured values (e.g., measured metrics or measured feature values) of the features of the semiconductor wafer or device. For example, to obtain the set of critical dimensions, the device can obtain a set of metrology images (e.g., 214) associated with the respective set of recipes. The metrology images may be SEM images or other types of images. One or more metrology images may be associated with each recipe of the set of recipes. The device can obtain the images by utilizing at least one suitable imaging tool or system (e.g., tool 212 used by a process engineer), for example. In some cases, the device can retrieve the metrology images of each recipe that are stored in the knowledge base.

After obtaining the images, the device can convert the set of metrology images to the respective set of critical dimensions. For example, the device can input the images to a conversion tool (e.g., 216) configured to detect the critical dimensions of various features of the semiconductor wafer presented in the images. The detected critical dimensions may be associated with features that are part of the set of criteria. In response to obtaining the critical dimensions, the device can store the critical dimensions in the knowledge base in association with at least one of the identifier of the scorecard, the set of metrology images, or the set of recipes. Other information related to the recipe can be stored in association with the identifier. In some cases, the device may retrieve the set of critical dimensions stored in the knowledge base in association with the images or the recipes, for example. In some implementations, the device can obtain a plurality of sets of critical dimensions. Each set of critical dimensions can include multiple critical dimensions that are associated with a respective recipe from the set of recipes.

At step 308, the device can obtain an objective function value (e.g., 230) of each recipe of the set of recipes using an analytic hierarchy process, for instance, with the set of critical dimensions, the set of criteria, and weights of the set of criteria as inputs. To use the analytic hierarchy process, the device can perform a pairwise comparison between a set of features associated with the set of critical dimensions and the set of criteria. For example, the features (or parameters) may be, for instance, OX/ACL selectivity, OX distortion, or other types of features. The device can pair each feature with other features. Each feature can be configured with a scale value, representing the importance of the feature of the semiconductor wafer to satisfy the corresponding criterion. The scale value can be configured by the administrator.

By using the pairwise comparison, the device can obtain a weight of each feature (or parameter) of the set of criteria according to the pairwise comparison (e.g., PCM). The device can input the weights of the features (or parameters), the critical dimensions (e.g., measured metrics), and the criteria (e.g., targeted metrics) to an objective function to obtain the objective function value for the respective recipe of the set of recipes. The device can repeat the process for other recipes to determine their objective function values. The device can include constraints for the calculation of the objective functions (e.g. barrier function) associated with tool guidelines or configured by the administrator.

At step 310, the device can select a subset of recipes according to the objective function value of each of the set of recipes. In some implementations, the device can rank the set of recipes (e.g., initial set of recipes) according to the objective function values. For example, the device can rank the recipes from smallest to largest, where the smallest objective function value represents that the recipe is more desirable (e.g., closer to satisfying the criteria). In this case, the device can select one or more recipes having the smallest objective function values compared to other recipes as part of the subset of recipes. In some other configurations, the larger objective function value may represent a more desirable recipe.

At step 312, the device can generate at least one recipe according to the selected subset of recipes and the objective function value. The at least one recipe can represent a new recipe (e.g., 236) or a candidate recipe, which may be a potential BKM. For example, to generate the at least one recipe, the device can determine, using at least the objective function value and at least one parameter of the subset of recipes associated with the set of criteria as inputs for an optimization function, an adjustment value for the at least one parameter. The at least one parameter can represent an instruction, technique, or setting indicated in the recipe for fabricating the semiconductor wafer or device. For example, an N₂ flow rate may be a parameter that affects the OX distortion and OX/ACL selectivity features. The device can utilize, for example, the example formulas (3) and (4) with the objective function value and at least one parameter of each recipe of the subset of recipes as inputs to determine a value for adjusting the at least one parameter.

Responsive to obtaining the adjustment value, the device can generate the at least one recipe including the adjustment value of the at least one parameter. The at least one recipe can represent a new recipe (e.g., 232) that includes the adjusted parameter value. With the new recipe, the device may repeat one or more processes, such as obtaining metrology images and critical dimensions and comparing the critical dimensions of the new recipe to the set of criteria to determine whether utilizing the new recipe result in features of the semiconductor wafer that satisfy the scorecard. In some implementations, if the device determines that the critical dimensions satisfy the criteria, the device can store and label the corresponding recipe as a BKM (e.g., 224) for the scorecard.

In some implementations, the device can determine whether the set of critical dimensions of a recipe (e.g., from the initial set of recipes) satisfies the set of criteria of the scorecard. Responsive to the set of critical dimensions satisfying the set of criteria, the device can store and label the recipe as BKM, which can be provided for display. If the critical dimensions associated with the recipe do not satisfy the criteria, the device can proceed to obtain the objective function value, among other processes discussed herein. In some cases, upon identifying at least one BKM (or a predetermined number of BKMs), the device may terminate the processes, and proceed to present the BKM to the administrator (e.g., process engineer).

At step 314, the device can display the generated at least one recipe via a display device. In this case, the at least one recipe, when used for fabricating the semiconductor device or wafer, can produce a wafer with features that satisfy the scorecard (e.g., the set of criteria). In such cases, the device can label the recipe as the BKM or one of the BKMs to be presented via the display device. The device can present the BKM(s) as recommendations for selection by the administrator. In some cases, the device may send the BKM(s) to another system or tool to automatically initiate the semiconductor wafer fabrication, for example.

FIG. 4 is a block diagram of an example computer system 400. The computer system or computing device 400 can include or be used to implement any computing device, processing system, or its components. The computing system 400 includes at least one bus 405 or other communication component for communicating information and at least one processor 410 or processing circuit coupled to the bus 405 for processing information. The computing system 400 can also include one or more processors 410 or processing circuits coupled to the bus for processing information. The computing system 400 also includes at least one main memory 415, such as a random access memory (RAM) or other dynamic storage device, coupled to the bus 405 for storing information, and instructions to be executed by the processor 410. The main memory 415 can also be used for storing position information, utility grid data, command instructions, device status information, environmental information within or external to the utility grid, information on characteristics of electricity, or other information during execution of instructions by the processor 410. The computing system 400 may further include at least one read only memory (ROM) 420 or other static storage device coupled to the bus 405 for storing static information and instructions for the processor 410. A storage device 425, such as a solid state device, magnetic disk or optical disk, can be coupled to the bus 405 to persistently store information and instructions.

The computing system 400 may be coupled via the bus 405 to a display 435, such as a liquid crystal display, or active matrix display, for displaying information to a user such as an administrator of the data processing system or the utility grid. An input device 430, such as a keyboard or voice interface may be coupled to the bus 405 for communicating information and commands to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435. The display 435 can be part of the computing device, or other components configured to perform the operations of the method 200, among others.

The processes, systems, and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “target substrate” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A system, comprising:
one or more processors and memory, the one or more processors configured to:
obtain, based on a scorecard for a set of criteria for fabricating a semiconductor device, a set of recipes stored in a knowledge base;
obtain a set of feature dimensions associated with the set of recipes;
obtain, using an analytic hierarchy process on the set of feature dimensions, the set of criteria, and weights of the set of criteria, an objective function value of each of the set of recipes;
select a subset of recipes according to the objective function value of each of the set of recipes;
generate at least one recipe according to the selected subset of recipes and the objective function value; and
display, via a display device, the generated at least one recipe.

2. The system of claim 1, wherein to obtain the set of feature dimensions, the one or more processors are configured to:
obtain a set of metrology images associated with the respective set of recipes; and
convert the set of metrology images to the respective set of feature dimensions.

3. The system of claim 1, wherein to obtain the set of feature dimensions, the one or more processors are configured to:
obtain a plurality of sets of feature dimensions, each set associated with a recipe of the set of recipes.

4. The system of claim 1, wherein to obtain the set of recipes, the one or more processors are configured to:
execute a semantic search in the knowledge base according to the set of criteria; and
receive, responsive to the semantic search, the set of recipes comprising one or more recipes having a set of features satisfying at least one criterion of the set of criteria.

5. The system of claim 1, wherein the one or more processors are configured to:
obtain an identifier associated with the scorecard;
store the identifier in the knowledge base; and
obtain the set of recipes associated with the identifier.

6. The system of claim 5, wherein the one or more processors are configured to:
store at least one of a set of metrology images, the set of feature dimensions, the subset of recipes, or the at least one recipe in association with the identifier.

7. The system of claim 1, wherein a set of metrology images corresponds to scanning electron microscopy (SEM) images.

8. The system of claim 1, wherein to use the analytic hierarchy process, the one or more processors are configured to:
perform a pairwise comparison between a set of features associated with the set of feature dimensions and the set of criteria;
obtain a weight of each feature of the set of features according to the pairwise comparison; and
obtain the objective function value of each of the set of recipes by using the respective set of feature dimensions, the set of criteria, and the weight as input for an objective function.

9. The system of claim 8, wherein each of the set of recipes is ranked according to the respective objective function value, and wherein the subset of recipes is selected according to smallest objective function value.

10. The system of claim 1, wherein to generate the at least one recipe, the one or more processors are configured to:
determine, using at least the objective function value and at least one parameter of the subset of recipes associated with the set of criteria as inputs for an optimization function, an adjustment value for the at least one parameter; and
generate the at least one recipe including the adjustment value of the at least one parameter.

11. The system of claim 1, wherein the one or more processors are configured to:
determine whether the set of feature dimensions of a recipe satisfies the set of criteria of the scorecard; and
responsive to the set of feature dimensions satisfying the set of criteria, provide the recipe for display via the display device.

12. The system of claim 11, wherein the one or more processors obtain the objective function value subsequent to determining that the set of feature dimensions of the recipe does not satisfy the set of criteria of the scorecard.

13. A method, comprising:
obtaining, by a device comprising one or more processors and memory, based on a scorecard including a set of criteria for fabricating a semiconductor device, a set of recipes stored in a knowledge base;
obtaining, by the device, a set of feature dimensions associated with the set of recipes;
obtaining, by the device, using an analytic hierarchy process on the set of feature dimensions, the set of criteria, and weights of the set of criteria, an objective function value of each of the set of recipes;
selecting, by the device, a subset of recipes according to the objective function value of each of the set of recipes;
generating, by the device, at least one recipe according to the selected subset of recipes and the objective function value; and
displaying, by the device, via a display device, the generated at least one recipe.

14. The method of claim 13, wherein obtaining the set of feature dimensions further comprises:
obtaining, by the device, a set of metrology images associated with the respective set of recipes; and
converting, by the device, the set of metrology images to the respective set of feature dimensions.

15. The method of claim 13, wherein obtaining the set of feature dimensions further comprises:
obtaining, by the device, a plurality of sets of feature dimensions, each set associated with a recipe of the set of recipes.

16. The method of claim 1, further comprising:
obtaining, by the device, an identifier associated with the scorecard;
storing, by the device, the identifier in the knowledge base; and
obtaining, by the device, the set of recipes associated with the identifier.

17. The method of claim 16, further comprising:
storing, by the device, at least one of a set of metrology images, the set of feature dimensions, the subset of recipes, or the at least one recipe in association with the identifier.

18. The method of claim 13, wherein using the analytic hierarchy process further comprises:
performing, by the device, a pairwise comparison between a set of features associated with the set of feature dimensions and the set of criteria;
obtaining, by the device, a weight of each feature of the set of features according to the pairwise comparison; and
obtaining, by the device, the objective function value of each of the set of recipes by using the respective set of feature dimensions, the set of criteria, and the weight as input for an objective function.

19. An apparatus, comprising:
a device comprising one or more processors and memory, configured to:
obtain, based on a scorecard including a set of criteria for fabricating a semiconductor device, a set of recipes stored in a knowledge base;
obtain a set of feature dimensions associated with the set of recipes;
obtain, using an analytic hierarchy process on the set of feature dimensions, the set of criteria, and weights of the set of criteria, an objective function value of each of the set of recipes;
select a subset of recipes according to the objective function value of each of the set of recipes;
generate at least one recipe according to the selected subset of recipes and the objective function value; and
display, via a display device, the generated at least one recipe.

20. The apparatus of claim 19, wherein the device is configured to:
determine whether the set of feature dimensions of a recipe satisfies the set of criteria of the scorecard; and
responsive to the set of feature dimensions satisfying the set of criteria, provide the recipe for display via the display device.
